(19) United States
(12) Patent Application Publication
(10) Pub. No.: US 2016/0146603 A1
(43) Pub. Date: May 26, 2016

(54) Levelling Device

(71) Applicants: Luke Lamont, North Lake (AU); Edward Joseph Khoury, Bateman (AU)

(72) Inventors: Luke Lamont, North Lake (AU); Edward Joseph Khoury, Bateman (AU)

(21) Appl. No.: 15/009,689

(22) Filed: Jan. 28, 2016

Related U.S. Application Data
(63) Continuation-in-part of application No. 14/358,040, filed on May 14, 2014, now abandoned.

(30) Foreign Application Priority Data
Nov. 14, 2011 (AU) 2011904727

(51) Int. Cl. G01C 9/28; G01C 9/34

(52) U.S. Cl. CPC G01C 9/28; G01C 9/34

(57) ABSTRACT

Described is a levelling device (10) comprising a body portion (12) having one or more level indicators (14) mourned therein and a pair of electrical socket pins (28) extending outwardly from a first side of the body portion (12) arranged to be received in apertures (29) provided in a power socket of a wall plate (26).

### CROSS-REFERENCE TO RELATED APPLICATIONS

This is a Continuation-in-Part Application of U.S. Non-Provisional Patent Application No. 14/358,040 filed May 14, 2014, entitled, “Levelling Device,” which is the National Stage of International Application No. PCT/AU2012/001396, filed Nov. 13, 2012.

### BACKGROUND OF THE INVENTION

(1) Field of Invention

The present invention relates to a device for levelling wall mounted plates and, more particularly, to a device for levelling wall mounted plates, including power sockets and light switches.

(2) Description of Related Art

A Variety of all mounted plates are used for different purposes in buildings. Electrical equipment, for example, commonly uses wall mounted plates, such as light switches and power sockets. These plates are affixed to the wall using conventional means, such as screws received through apertures in the plate.

It is desirable with such wall mounted plates to ensure that the edges of the plates are oriented level. In order to achieve this accurately, devices such as spirit levels may be used. However, some wall plates do not have straight edges against which the level can be held. Also, in many situations an installer may simply set the orientation of the plate by eye due to the inconvenience of using a conventional spirit level. Any resulting tilt in the wall mounted plate results in an unsatisfactory appearance.

Thus, a continuing need exists for a device for leveling a wall mounted plate, such as an electrical wall plate, which is aimed at being easy and convenient to use.

### SUMMARY OF THE INVENTION

The present invention relates to a device for levelling wall mounted plates and, more particularly, to a device for levelling wall mounted plates, including power sockets and light switches. According to one aspect of the present invention there is provided a levelling device comprising a body portion having one or more level indicators; a pair of electrical socket pins extending outwardly from the body; a pair of studs extending outwardly from a side surface of the body; and one or more openings provided through the body. The electrical socket pins are receivable in apertures of a power socket and the studs are receivable in apertures in a wall plate such that the openings in the body provide access for a screwdriver to allow tightening of screws of the wall plate.

In another aspect, lint and second level indicators are provided, each comprising a spirit level tube such that the first spirit level tube is oriented to be perpendicular to the second spirit level tube.

In another aspect, the body portion is generally elongate in shape and the electrical socket pins are provided extending generally outwardly from adjacent a midpoint thereof.

In another aspect, the body portion comprises first and second parallel side members and first and second end members, the first end member joining the first and second side members adjacent first ends thereof and the second end member joining the first and second side members adjacent second ends thereof.

In another aspect, electrical socket pins extend outwardly from a side of the first side member.

In another aspect, the studs include a first pair of studs extending outwardly from the first side member, adjacent opposed ends of the side member.

In another aspect, the first studs are received in holes in the body portion such that outer ends thereof extend beyond the body portion and inner ends are contained within the holes and wherein the studs are spring biased such that the studs may be pushed inwardly into the holes but will move back outwardly from the holes when released.

In another aspect, the spring bias is provided by springs provided within the holes in engagement with inner ends of the studs.

In another aspect, a first cross member extends between the first and second side members adjacent a first end to define as first opening and a second cross member extends between the first and second side members adjacent a second end to define a second opening.

In another aspect, a central opening is defined between the first and second cross members such that the first level indicator is provided in the central opening and the second level indicator is provided in the first opening.

In another aspect, a third level indicator is provided in the second opening such that the first, second and third level indicators are perpendicular to each other.

In another aspect, a second pair of studs is provided on a first side surface of the body to be received in apertures in the wall plate.

In another aspect, the second pair of studs is provided on the first and second end members.

In another aspect, a third pair of studs is provided on a second opposite side surface of the body to be received in apertures in the wall plate, the distance between the third studs being less than the distance between the second studs.

In another aspect, the third studs are provided on the first and second cross members.

In another aspect, a pair of ribs comprising elongate protrusions are provided extending outwardly from a side surface of the second side member.

In another aspect, the ribs are oriented parallel to the longitudinal axis of the second side member and are adjacent each other to define an elongate gap. Preferably a first of the ribs is planar and a second of the ribs is arcuate such that a concave face thereof is adjacent the planar first rib.

In another aspect, the electrical socket pins extend outwardly from a first side surface of the body.

In another aspect, there is provided a pair of cylindrical tugs located adjacent opposed ends of the body portion on a second side of the body portion for engaging with apertures in a wall plate for receiving securing screws.

In another aspect, the openings are provided in the body portion extending from the first side surface through to the interior of the lugs such that a screwdriver may be passed through the openings from the first side surface and out of the centre of the lugs to secure a wall plate engaged with the levelling device.

In another aspect, the pair of fast studs is provided extending outwardly from the first side surface of the body for engaging with apertures in a wall plate.

In another aspect, a central member is provided, extending generally between a midpoint of the first side member and a midpoint of the second side member such that a first opening is defined between the first end member and the central member a second opening is defined between the second end member and the central member, the first level indicator being provided in the first opening and the second level indicator being provided in the second opening.

In another aspect, the electrical socket pins are located on the central member, the first cylindrical lugs and the first studs are located on the first end member and the second cylindrical lugs and the second studs are located on the second end member.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1a is as first, upper perspective-view illustration of a levelling device in accordance with the present invention;

FIG. 1b is a second, upper perspective-view illustration of the levelling device of FIG. 1a in accordance with the present invention;

FIG. 2a is a front-view illustration of the levelling device of FIGS. 1a and 1b in accordance with the present invention;

FIG. 2b is a rear-view illustration of the levelling device of FIGS. 1a and 1b in accordance with the present invention;

FIG. 3a is a side-view illustration of the levelling device of FIGS. 1a and 1b in accordance with the present invention;

FIG. 3b is a top-view illustration of the levelling device of FIG. 1 in accordance with the present invention;

FIG. 4 is an exploded-view illustration of the levelling device of FIGS. 1a and 1b in accordance with the present invention;

FIG. 5a is an upper, perspective-view illustration of the levelling device of FIGS. 1a and 1b prior to engagement with a power socket in accordance with the present invention;

FIG. 5b is a side-view illustration of the levelling device of FIGS. 1a and 1b prior to engagement with the power socket in accordance with the present invention;

FIG. 5c is a side-view illustration of the levelling device of FIGS. 1a and 1b engaged with the power socket in accordance with the present invention;

FIG. 5d is a front-view illustration of the levelling device of FIGS. 1a and 1b engaged with the power socket in accordance with the present invention;

FIG. 5e is a side, cross-sectional-view illustration of the levelling device of FIGS. 1a and 1b engaged with the power socket in accordance with the present invention;

FIG. 5f is an enlarged-view illustration of Detail A of FIG. 5e in accordance with the present invention;

FIG. 6a is an upper, perspective-view illustration of the levelling device of FIG. 1 prior to engagement with a light switch in accordance with the present invention;

FIG. 6b is a front-view illustration of the levelling device of FIGS. 1a and 1b engaged with the light switch in accordance with the present invention;

FIG. 6c is an upper, perspective-view illustration of the levelling device of FIGS. 1a and 1b engaged with the light switch showing tightening of the switch plate securing screws in accordance with the present invention;

FIG. 6d is a top-view illustration of the levelling device of FIGS. 1a and 1b engaged with the light switch showing tightening of the switch plate securing screws in accordance with the present invention;

FIG. 7a is an upper, perspective-view illustration of the levelling device of FIGS. 1a and 1b prior to engagement with an alternative light switch in accordance with the present invention;

FIG. 7b is a top-view illustration of the levelling device of FIGS. 1a and 1b engaged with the light switch of FIG. 7a in accordance with the present invention;

FIG. 7c is a front-view illustration of the levelling device of FIGS. 1a and 1b engaged with the light switch of FIG. 7a in accordance with the present invention;

FIG. 8a is an upper, perspective-view illustration of the levelling device of FIGS. 1a and 1b prior to engagement with a mourning plate in accordance with the present invention;

FIG. 8b is a top-view illustration of the levelling device of FIGS. 1a and 1b prior to engagement with the mounting plate of FIG. 8a in accordance with the present invention;

FIG. 8c is a from-view illustration of the levelling device of FIGS. 1a and 1b engaged with the mounting plate of FIG. 8a in accordance with the present invention;

FIG. 9a is an upper, perspective-view illustration of the levelling device of FIGS. 1a and 1b prior to engagement with an alternative mounting plate in accordance with the present invention;

FIG. 9b is a front-view illustration of the levelling device of FIGS. 1a and 1b engaged with the mounting plate of FIG. 9a in accordance with the present invention;

FIG. 10a is a first, perspective-view illustration of a second embodiment of a levelling device in accordance with the present invention;

FIG. 10b is a second, perspective-view illustration of the levelling device of FIG. 10a in accordance with the present invention;

FIG. 11a is a front-view illustration of the levelling device of FIGS. 10a and 10b in accordance with the present invention;

FIG. 11b is a rear-view illustration of the levelling device of FIGS. 10a and 10b in accordance with the present invention;

FIG. 12a is a first, side-view illustration of the levelling device of FIGS. 10a and 10b in accordance with the present invention;

FIG. 12b is a second, side-view illustration of the levelling device of FIGS. 10a and 10b in accordance with the present invention;

FIG. 13a is a top-view illustration of the levelling device of FIGS. 10a and 10b in accordance with the present invention;

FIG. 13b is a bottom-view illustration of the levelling device of FIGS. 10a and 10b in accordance with the present invention;

FIG. 14a is a front-view illustration of the levelling device of FIGS. 10a and 10b in accordance with the present invention;

FIG. 14b is a cross-sectional-view illustration of the levelling device of FIG. 14a through the line A-A in accordance with the present invention;

FIG. 15a is a front-view illustration of the levelling device of FIGS. 10a and 10b in accordance with the present invention;

FIG. 15b is a cross-sectional-view illustration of the levelling device of FIG. 15a through the line B-B in accordance with the present invention;

FIG. 16a is a side-view illustration of the levelling device of FIGS. 10a and 10b in accordance with the present invention;

FIG. 16b is a cross-sectional-view of the levelling device of FIG. 16a through the line C-C in accordance with the present invention;

FIG. 17 is an illustration of the levelling device engaged with a socket by the electrical pins in accordance with the present invention;

FIG. 18a is a front-view illustration of the levelling device engaged with the socket by the first studs in accordance with the present invention;

FIG. 18b is a cross-sectional-view illustration of the arrangement of FIG. 18a through the line D-D accordance with the present invention;

FIG. 19a is a front-view illustration of the levelling device engaged with a wall plate by studs on a second side surface of the levelling device in accordance with the present invention;

FIG. 19b is a cross-sectional-view illustration of the levelling device of FIG. 19a through the line E-E in accordance with the present invention; and

FIG. 20 is a front-view illustration of the levelling device engaged with a wall plate by ribs on the second side member.

### DETAILED DESCRIPTION

The present invention relates to a device for levelling wall mounted plates and, more particularly, to a device for levelling wall mounted plates, including power sockets and light switches. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block, diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features,

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Specific Details

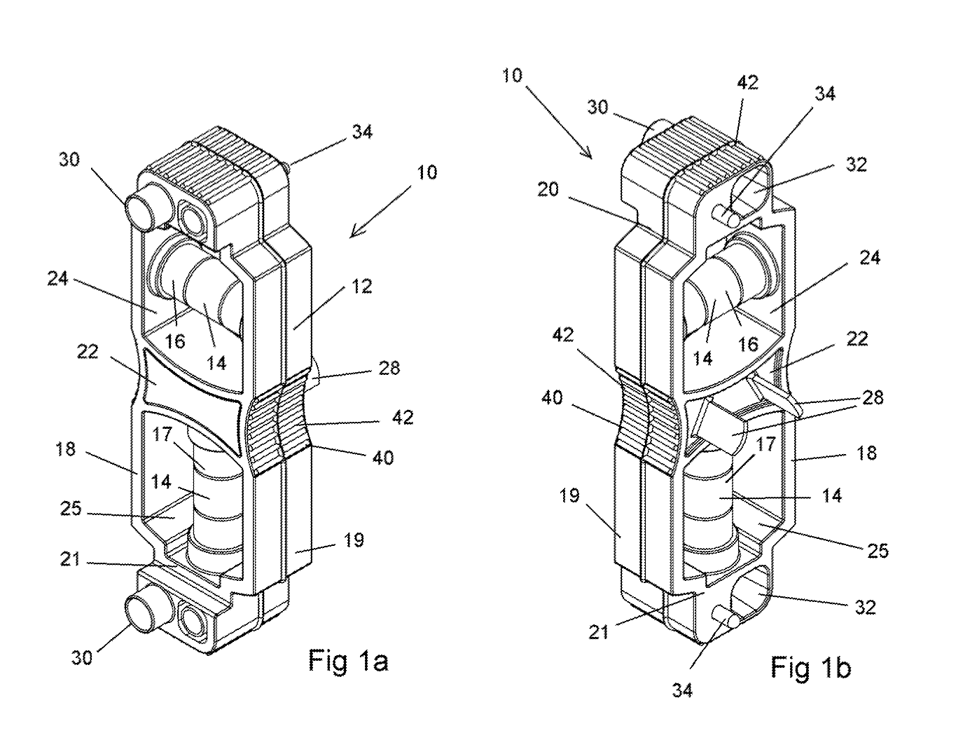

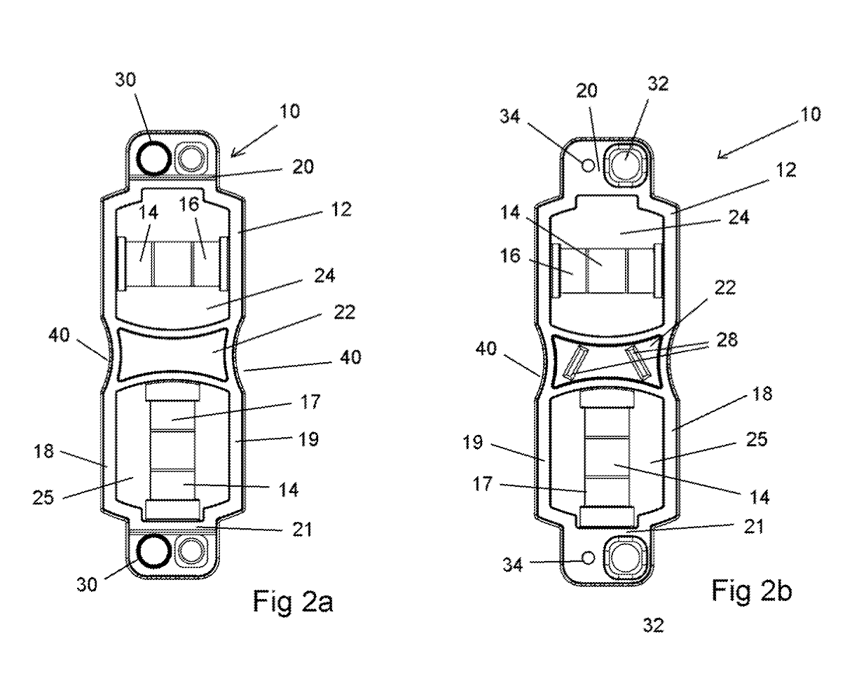

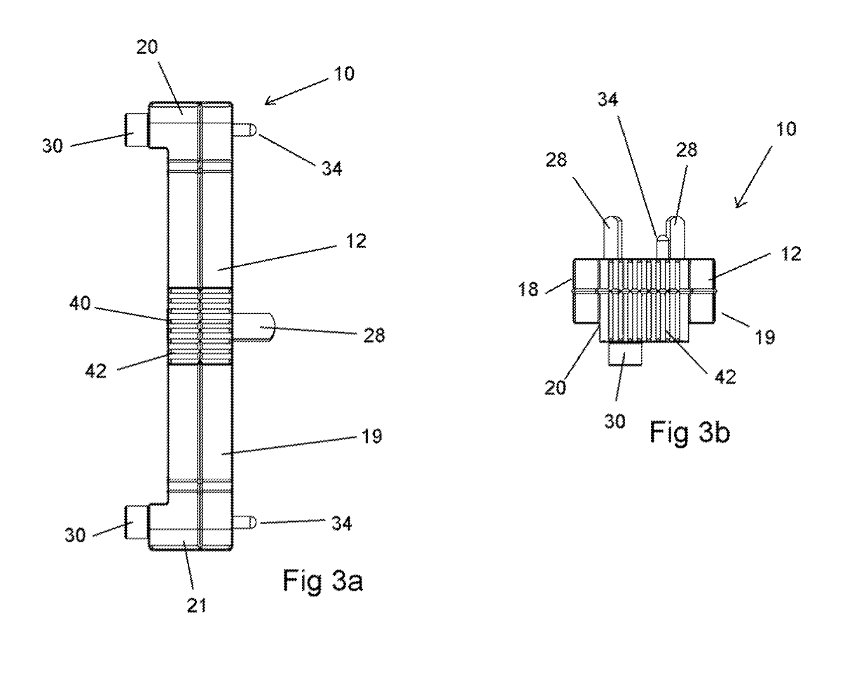

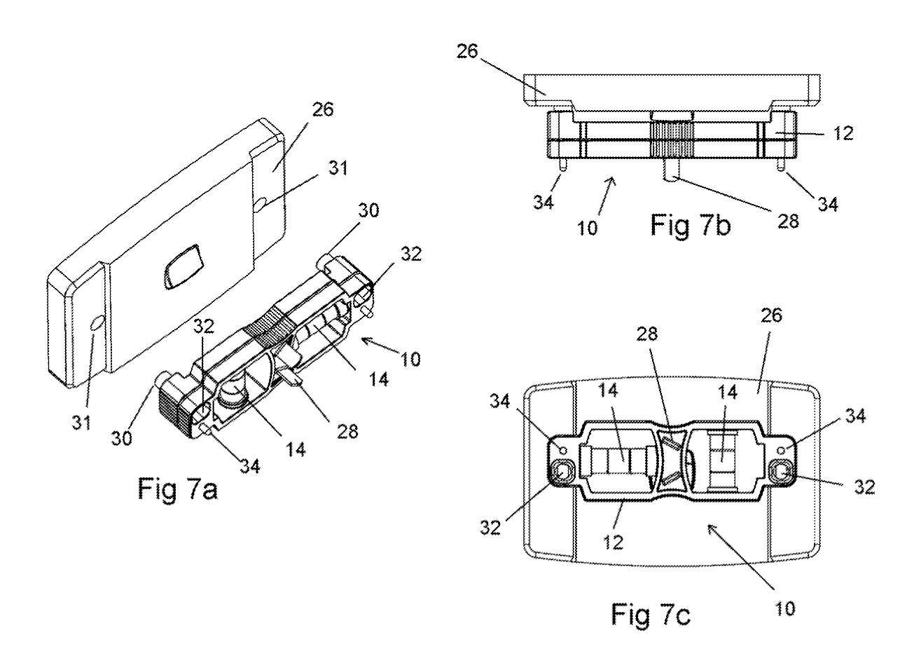

Referring to FIGS. 1 to 9, there is shown a first embodiment of a levelling device 10 in accordance with the present invention. The levelling device comprises a body portion 12 having one or more level indicators 14 mounted therein. In the embodiment shown, there is provided a first level indicator 16 and a second level indicator 17. Each of the first and second level indicators 16 and 17 comprise a spirit level tube. The first and second spirit level tubes are arranged perpendicular to each other to provide an indication of whether the body portion 12 is level in either the horizontal or vertical orientation.

In the embodiment shown, the body portion 12 comprises first and second parallel side members 18 and 19 and first and second end members 20 and 21. The first end member 20 joins the first and second side members 18 and 19 adjacent first ends thereof and the second end member 21 joins the first and second side members 18 and 19 adjacent second ends thereof. There is also provided a central member 22 which extends generally between a midpoint of the first side member 18 and a midpoint oldie second side member 19.

The body portion 12 is therefore generally elongate in shape, being rectangular, and includes a first opening 24 defined between the first end member 20 and the central member 22 and a second opening 25 defined between the central member 22 and the second end member 21. The first level indicator 16 is provided in the first opening 24 and the second level indicator 17 is provided in the second opening 25. The first level indicator 16 extends between the first and second side members 18 and 19 and the second level indicator 17 extends between the central member 22 and the second end member 21.

The levelling device 10 is provided with one or more sets of protrusions provided for engaging with apertures in a wall plate 26. The apertures in the wall plate 26 may comprise the apertures provided for receiving securing screws, or the apertures in a socket type plate provided for receiving the pins of a power plug in use.

In the embodiment shown, the body portion 12 of the levelling device 10 is provided with a first set of protrusions on a first side surface thereof comprising a pair of electrical socket pins 28. The electrical socket pins 28 are provided to be received in apertures 29 of a power socket provided on the wall plate 26. In the embodiment of FIGS. 1 to 9, the electrical socket pins 28 comprise the angled flat pins used as the active and neutral pins for Australian electrical sockets. It will be appreciated however that the electrical socket pins 28 may comprise alternative shapes for fitting into power sockets used in other countries. The electrical socket pins 28 extend from the central member 22 such that the electrical socket pins 28 extend outwardly from adjacent a midpoint of the elongate body portion 12.

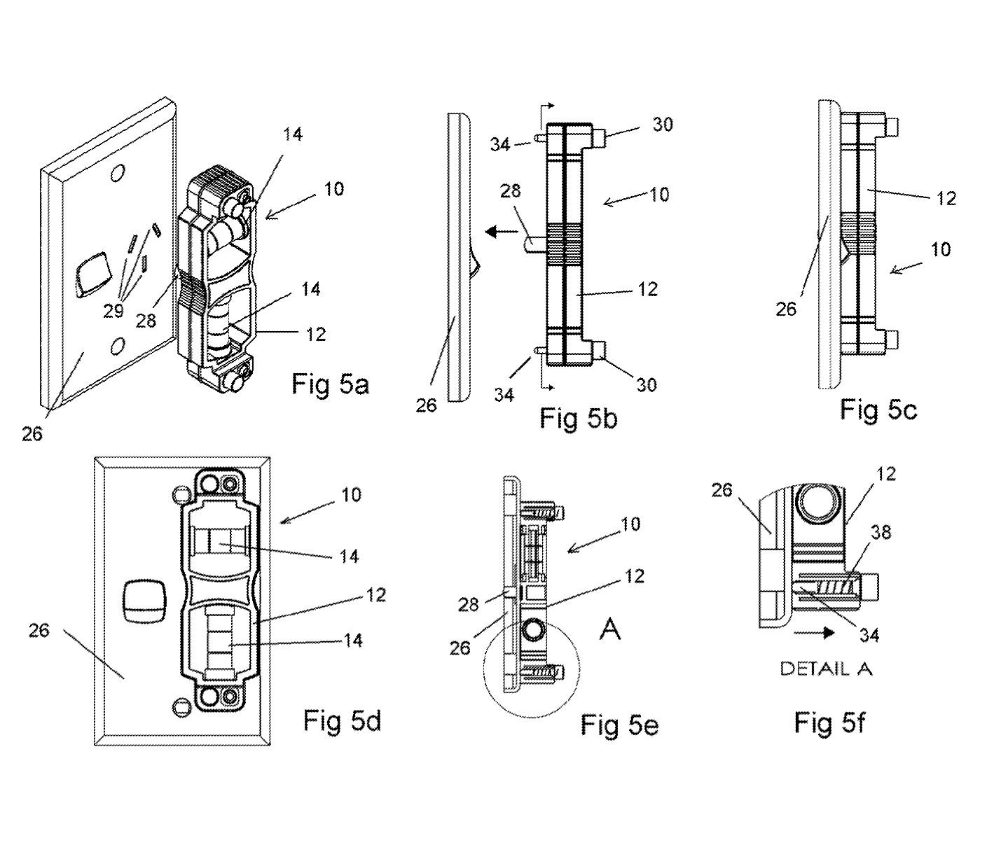

In the embodiment shown, the electrical socket pins 28 are oriented such that when the electrical socket pins 28 are received in the apertures 29 of the power socket (as shown in FIG. 5), the first and second side members 18 and 19 are generally vertical. The first level indicator 16 can therefore provide an indication of whether the wall plate 26 is level.

The levelling device 10 is also provided with a second set of protrusions comprising a pair of lugs 30 on a second side of the body portion 12, the second side being opposite the first side thereof. A first of the lugs 30 is provided adjacent a first end of the body portion 12 and a second of the lugs 30 is provided adjacent a second remote end of the body portion 12. That is, the first and second lugs 30 are provided adjacent either end of the body portion 12 with the electrical socket pins 28 located generally between the lugs 30.

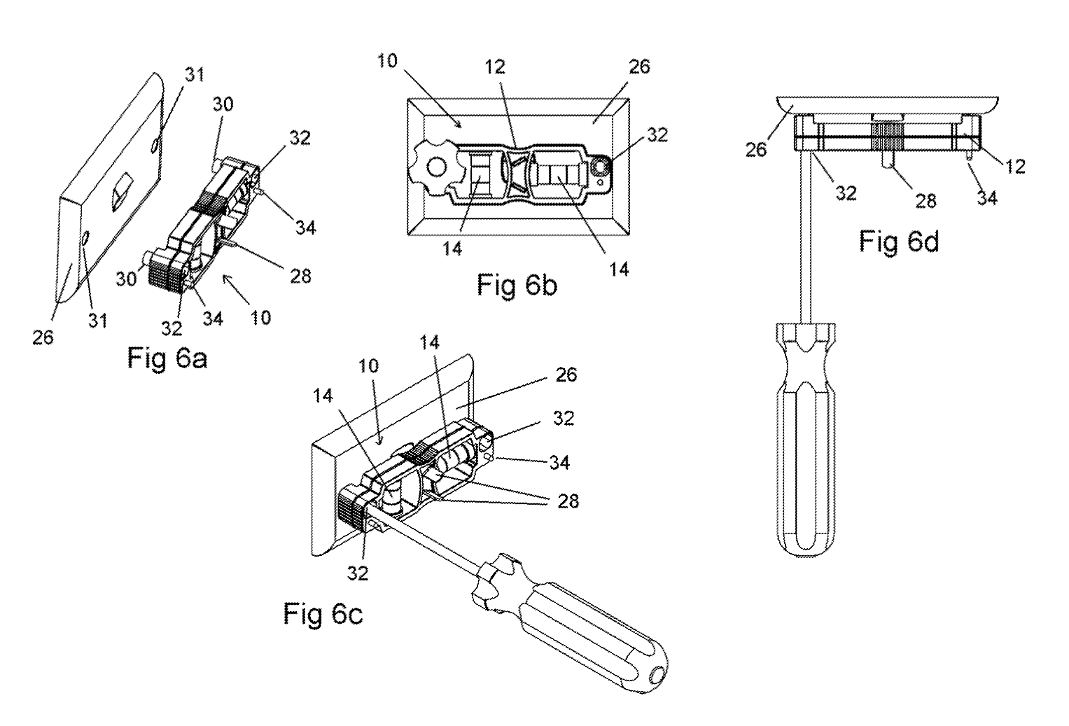

The lags 30 are generally cylindrical in shape. A first of the lugs 30 is provided on the first end member 20 and second of the lugs 30 is provided on the second end member 21. Each of the lugs 30 is sized to be received in an aperture 31 in the wall plate 26 that would be used to receive a securing screw. The distance between the lugs 30 is set to be equivalent to the standard distance between the apertures 31 of a standard wall plate 26. The lugs 30 are arranged such that a line extending between the protrusions 30 is parallel to the first and second side members 18 and 19. Therefore, when the lugs 30 are received in the apertures 31 of a wall plate 26, such as a switch plate (as shown in FIG. 6), the level indicators 14 provide an indication of whether wall plate 26 is level.

The lugs 30 are hollow and openings 32 are provided in the body portion 12 such that the openings 32 align with the interior of the lugs 30. The openings 32 extend from the first side surface of the body portion 12 through to the interior of the lugs 30 such that a screwdriver may be passed through the openings 32 from the first side surface and out of the centre of the lugs 30. As can be seen in FIG. 6, this allows the levelling device 10 to be engaged with the wall plate 26 and screws of the wall plate 26 may be tightened with the levelling device 10 remaining in place (as shown in FIGS. 6c and 6d) to indicate that the wall plate 26 is level.

The levelling device 10 is also provided with a set of third protrusions comprising a pair of first studs 34 extending outwardly from the first side of the body portion 12. The lust studs 34 are also provided on the body portion 12 such that one of the first studs 34 is adjacent the first end of the body portion 12 and the other of the first studs 34 is adjacent the second end of the body portion 12.

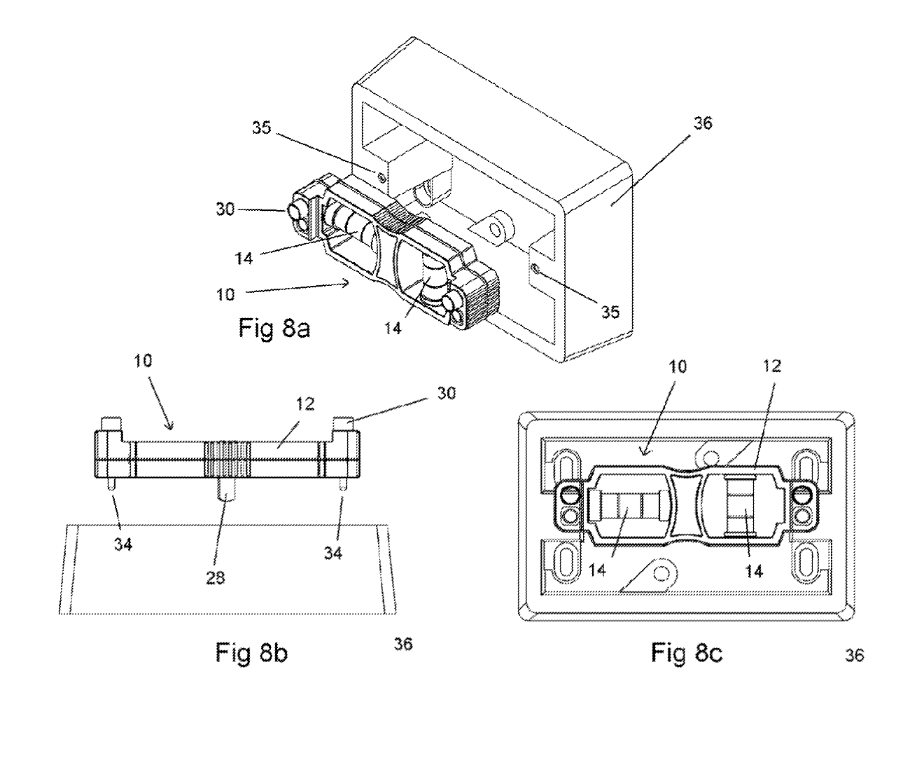

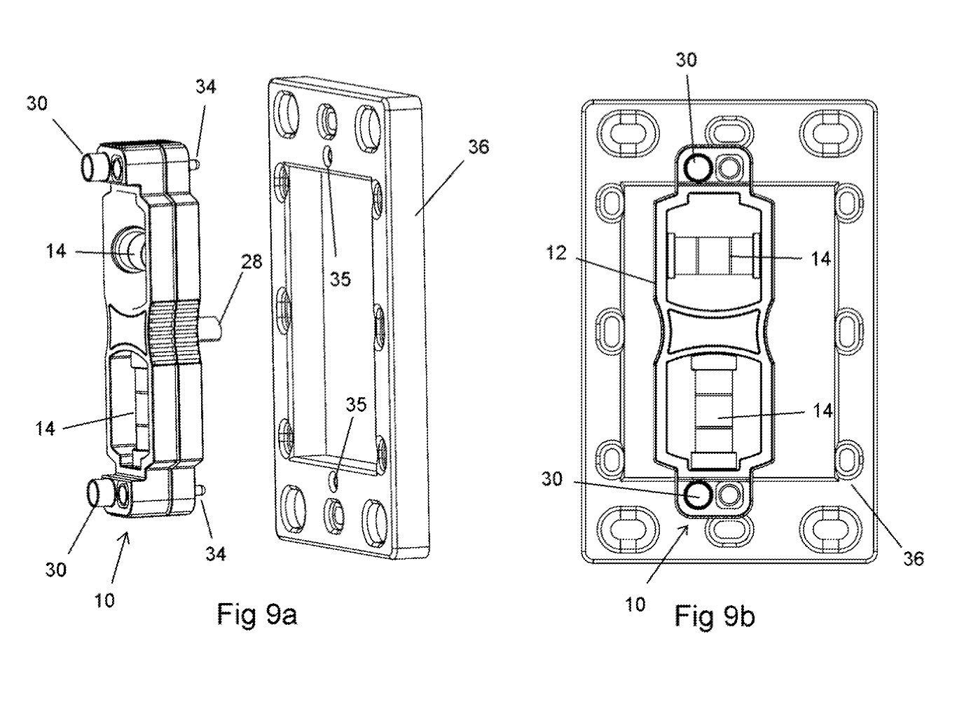

The first studs 34 are provided on the first and second end members 20 and 21 respectively. As can be seen in FIGS. 8 and 9, the first studs 34 are provided to be received in apertures 35 of a mounting block 36 on which a wall plate 26 may be mounted. The studs 34 are locatable in the apertures 35 such that the levelling device 10 provides an indication of whether the mounting block 36 is level, in the same manner as for the wall plate 26.

The first studs 34 are received in holes 37 in the body portion 12 such that outer ends thereof extend beyond the body portion 12 and inner ends are contained within the holes 37. The first studs 34 may be pushed inwardly into the holes 37 but are spring biased such that the first studs 34 will move back outwardly from the holes 37 when released. The spring bias is provided by springs 38 provided within the holes 37 in engagement with inner ends of the studs 34 such that pressing the first studs 34 into the holes 37 compresses the springs 38. This arrangement is provided such that when the electrical pins 28 are located in a power socket, the first studs 34 can push hack into the body portion 12 so they do not damage or mark the wall plate 26.

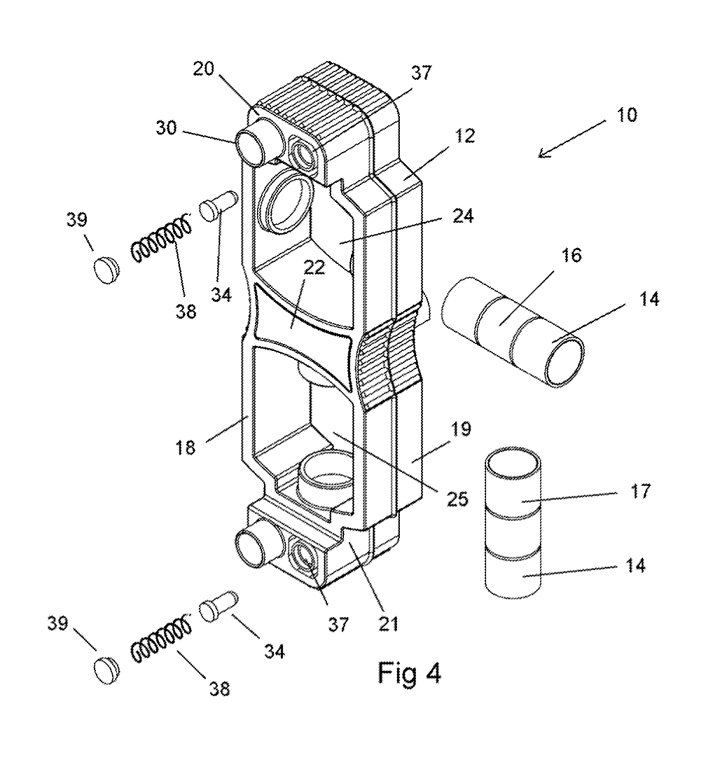

The first studs 34 and the springs 38 may be received in the holes 37 from the second side surface of the body portion 12 (as shown in FIG. 4) and secured in place by caps 39 which seal across the holes 37 adjacent the second side surface.

The first and second side members 18 and 19 are also provided with indents 40 midway along the outer surfaces thereof. The indents 40 are provided with ribbing 42 so that the body portion 12 may be easily gripped by placing fingers into the indents 40. The ends of the first and second end members 20 and 21 are also provided with ribbing 42 to aid holding of the body portion 12 between the fingers by the end members 20 and 21.

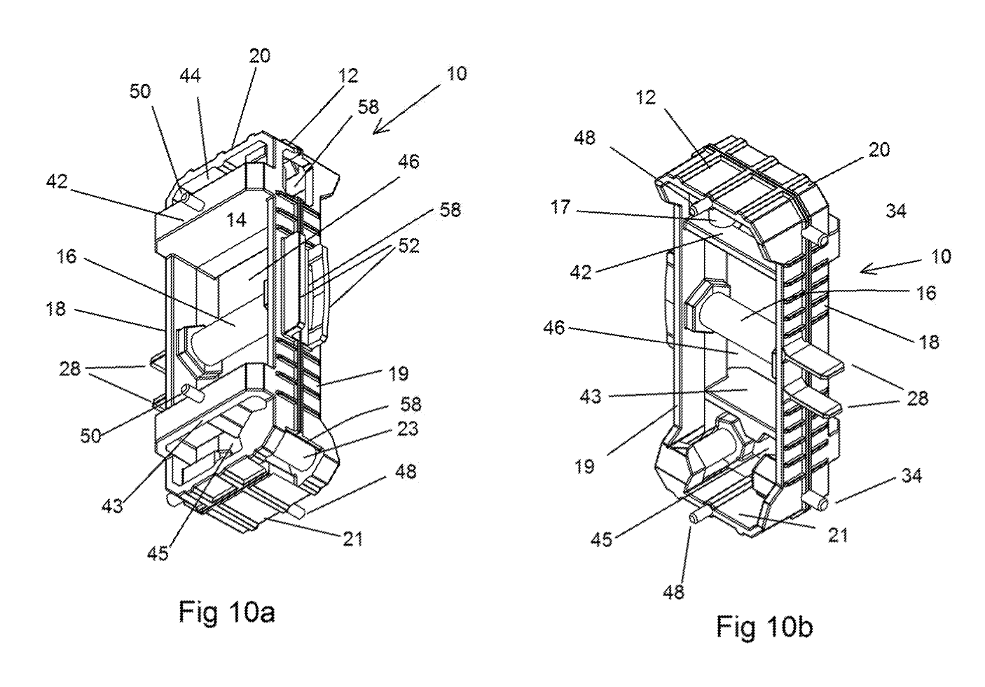

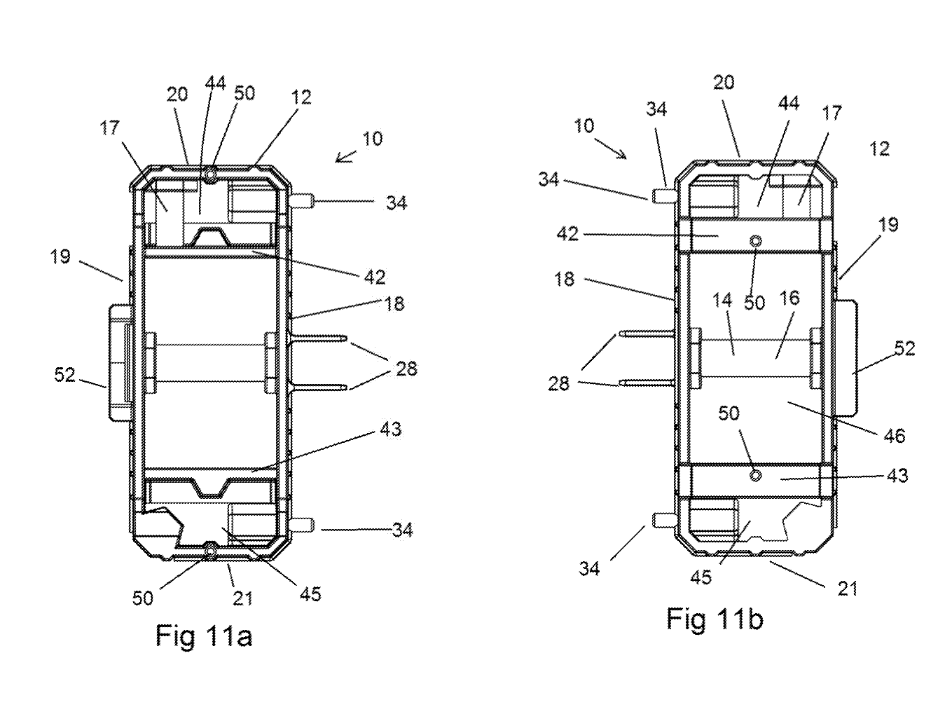

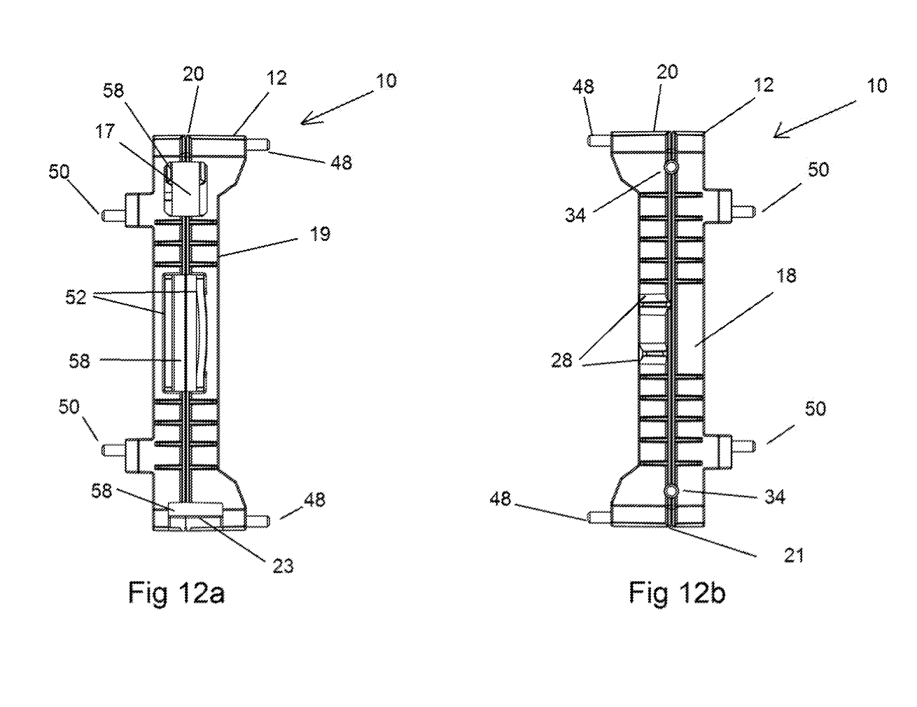

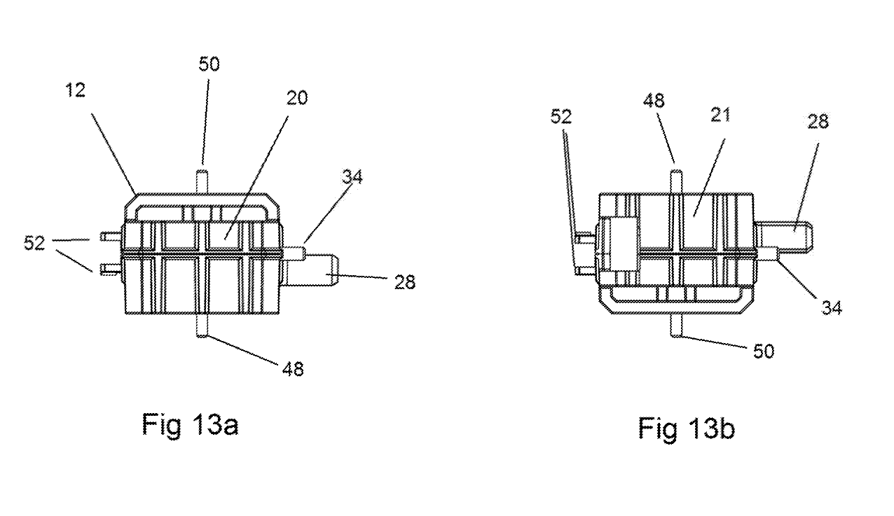

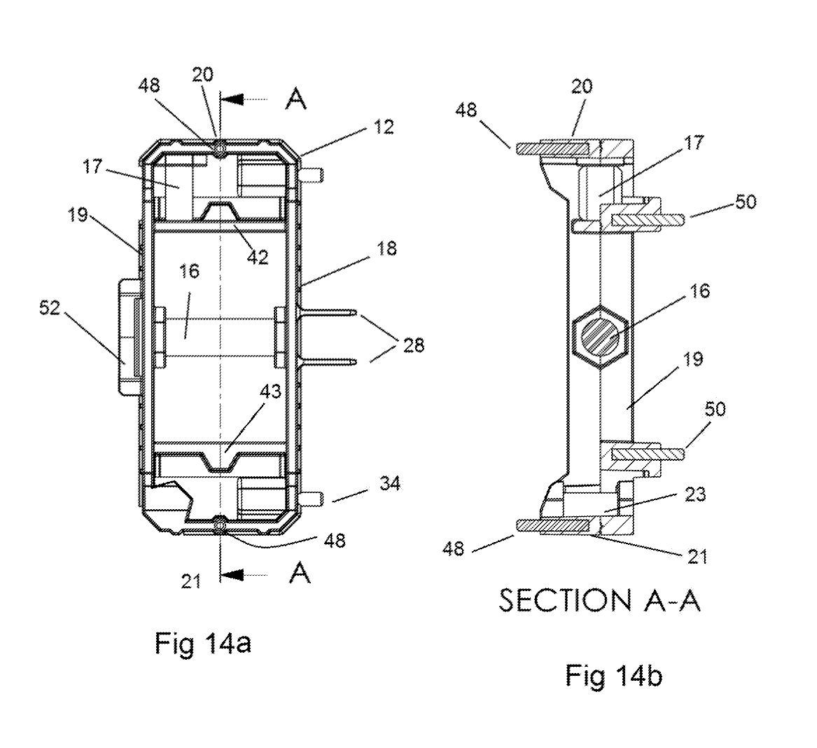

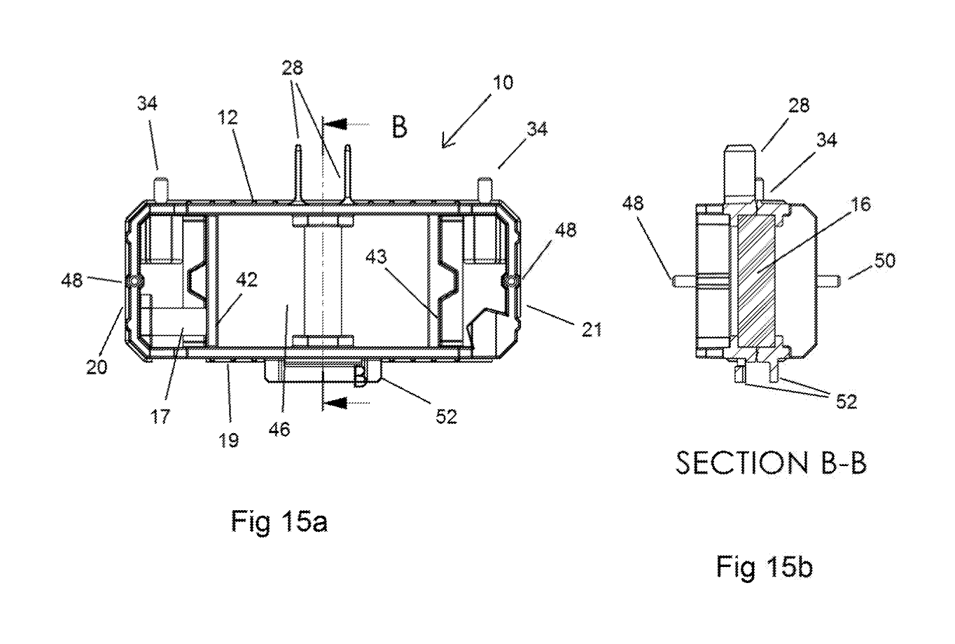

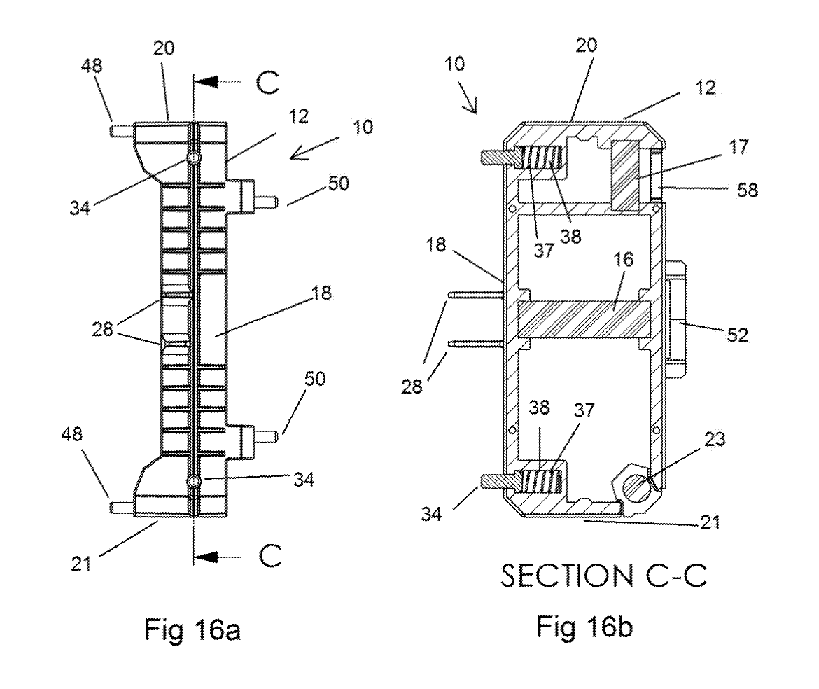

FIGS. 10 to 20 show a second embodiment of a levelling device 10 in accordance with the present invention. The levelling device 10 of FIGS. 10 to 20 is similar to the embodiment of FIGS. 1 to 9 and like reference numerals are used to denote like parts.

The levelling device comprises also a body 12 formed of first and second side members 18 and 19 and first and second end members 20 and 21. First and second level indicators 16 and 17 are mounted within the body 12.

The electrical socket pins 28 comprise straight flat pins of a shape to be received in electrical sockets of the type used in the USA. The electrical socket pins 28 extend outwardly from a side surface of the first side member 18 of the body 12, generally midway the first and second end members 20 and 21. The first studs 34 also extend outwardly from the side surface of the first side member 18, adjacent opposed ends thereof. The first studs 34 are spring biased in the same manner as the first embodiment such that the first studs are retractable into the body 12.

The body 12 includes a first cross member 42 extending between the first and second side members 18 and 19 adjacent the first end member 20. A second cross member 43 is provided extending between the first and second side members 18 and 19 adjacent the second end member 21. A first opening 44 is therefore defined in the body 12 between the first cross member 42 and the first end member 20 and a second opening 45 is defined between the second cross member 43 and the second end member 21.

A central opening 46 is defined between the first and second cross members 42 and 43. In the embodiment shown, the first level indicator 16 is provided in the central opening 46, mounted between the first and second side members 18 and 19. The second level indicator 19 is mounted in the first opening between the first cross member 42 and the first end member 20. A third level indicator 23 is also provided in the second opening 45. The third indicator 23 extends between the first and second side surfaces of the body 12 such that the first, second and third level indicators 16, 17 and 23 are perpendicular to each other.

The body 12 is provided also with a pair of second studs 48. The second studs 48 extend outwardly from the first side surface of the body 12 adjacent opposed ends thereof. A first of the second studs 48 extends outwardly from the first end member 20 and a second of the second studs 48 extends outwardly from the second end member 21.

The body 12 is pros Lied also with a pair of third studs 48. The third studs 50 extend outwardly from the second side surface of the body 12 adjacent opposed ends thereof. The distance between the third studs 50 is less than the distance between the second studs 48. A first of the third studs 50 extends outwardly from the first cross member 42 and a second of the third studs 50 extends outwardly from the second cross member 43.

The levelling device 10 is provided also with a pair of ribs 52. The ribs 52 comprise elongate protrusions extending outwardly from a side surface of the second side member 19. The ribs 52 are oriented parallel to the longitudinal axis of the second side member 19 and are adjacent each other to define an elongate gap 54 between the ribs 52. A first of the ribs 52 is planar and a second of the ribs 52 is arcuate. The second arcuate rib 52 is arranged such that a concave face thereof is adjacent the planar first rib 52.

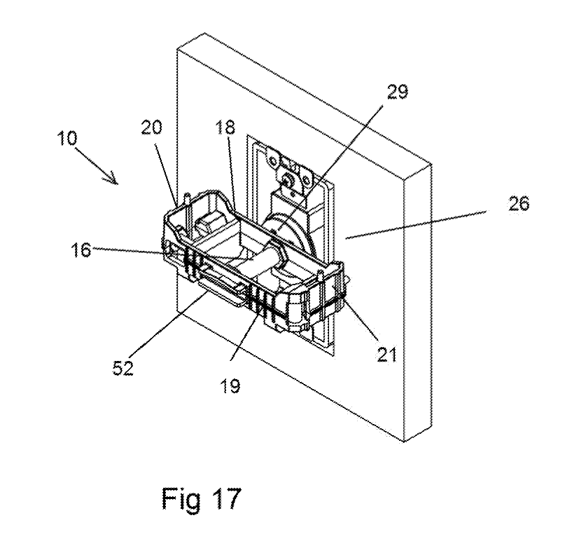

In use, the levelling device 10 may be used in a number of orientations. As shown in FIG. 17, the electrical socket pins 28 may be received in a socket 29 of a wall plate 26 to allow the wall plate 26 to be levelled.

The first, second or third studs 34, 48 or 50 may also be received in apertures provided in a wall plate 26 or mounting block 36 for levelling the wall plate 26 or mounting, block 63. The distances between the studs 34, 48, 50 are set to be received in holes in standard wall plates 26 or mounting blocks 36 and the appropriate studs 34, 48, or 50 may be selected based on the type of wall plate 26 or mourning block 36.

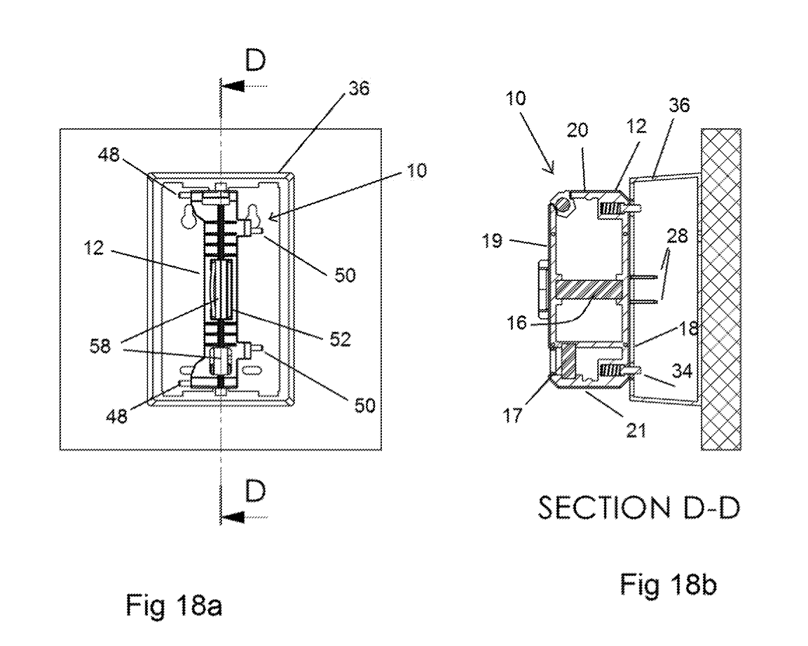

FIG. 18 shows use of the levelling device 10 by engaging the first studs 34 with the mounting block 36. As cart be seen, the second side member 19 is provided with ports 58 such that the level indicators 16 and 17 may be viewed through the second side member 19. A further port 58 is provided in the second side member 19 extending into the second end member 21 such that the third level indicator 23 can be viewed through the further port 58.

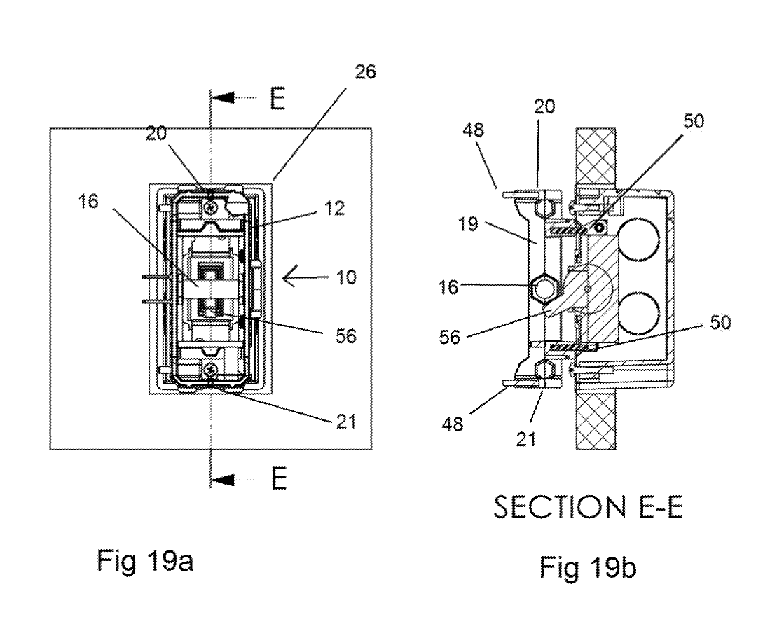

FIG. 19 shows use of the third studs 50 for levelling a wall plate 26 including a switch 56. In this operation, the central opening 46 receives the switch 56. The first and second openings 44 and 45 provide access through the body 12 to the securing screws of the wall plate 26 (as best seen in FIG. 18a). The screws may thereby be tightened with the levelling device 10 in place.

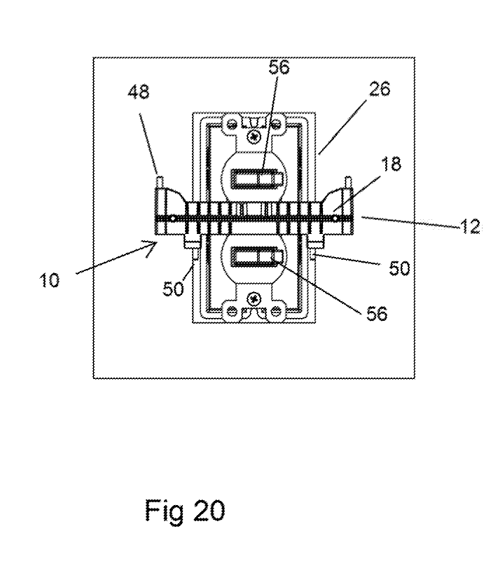

The ribs 52 may also be used to engage a wall plate 26. FIG. 20 shows an example where the ribs 52 are fitted between a pair of switches 56. The ribs 52 are flexible and resilient such that the first and second ribs 52 may be compressed towards each other. The ribs 52 may therefore be pressed between the switches 56 and the body 12 of the levelling device 10 is held in place by the ribs 52 to allow levelling of the wall plate 26.

It will be readily apparent to persons skilled in the relevant arts that various modifications and improvements may be made to the foregoing embodiments, in addition to those already described, without departing from the basic inventive concepts of the present invention.

What is claimed is:

1. A levelling device comprising:
a body portion having one or more level indicators;
a pair of electrical socket pins extending outwardly from the body;
a pair of studs extending outwardly from a side surface of the body; and
one or more openings provided through the body;
wherein the electrical socket pins are receivable in apertures of a power socket and wherein the studs are receivable in apertures in a wall plate such that the openings in the body provide access for a screwdriver to allow tightening of screws of the wall plate.

2. A levelling device in accordance with claim 1, wherein first and second level indicators are provided, each comprising a spirit level tube such that the first spirit level tube is oriented to be perpendicular to the second spirit level tube.

3. A levelling device in accordance with claim 2, wherein the body portion is generally elongate in shape and the electrical socket pins are provided extending generally outwardly from adjacent a midpoint thereof.

4. A levelling device with claim 2, wherein the body portion comprises first and second parallel side members and first and second end members, the first end member joining the first and second side members adjacent first ends thereof and the second end member joining the first and second side members adjacent second ends thereof.

5. A levelling device in accordance with claim 4, wherein electrical socket pins extend outwardly from a side of the first side member.

6. A levelling device in accordance with claim 5, wherein the studs include a first pair of studs extending outwardly from the first side member, adjacent opposed ends of the side member.

7. A levelling device in accordance with claim 6, wherein the first studs are received in holes in the body portion such that outer ends thereof extend beyond the body portion and inner ends are contained within the holes and wherein the studs are spring biased such that the studs may be pushed inwardly into the holes but will move back outwardly from the holes when released.

8. A levelling device in accordance with claim 7, wherein the spring bias is provided by springs provided within the holes in engagement with inner ends of the studs.

9. A levelling device in accordance with claim 4, wherein a first cross member extends between the first and second side members adjacent a first end to define a first opening and a second cross member extends between the first and second side members adjacent a second end to define a second opening.

10. A levelling device in accordance with claim 9, wherein a central opening is defined between the first and second cross members such that the first level indicator is provided in the central opening and the second level indicator is provided in the first opening.

11. A levelling device in accordance with claim 10, wherein a third level indicator is provided in the second opening such that the first, second and third level indicators are perpendicular to each other.

12. A levelling device in accordance with claim 9, wherein a second pair of studs is provided on a first side surface of the body to be received in apertures in the wall plate.

13. A levelling device in accordance with claim 12, wherein the second pair of studs is provided on the first and second end members.

14. A levelling device in accordance with claim 13, wherein a third pair of studs is provided on a second opposite side surface of the body to be received in apertures in the wall plate, the distance between the third studs being less than the distance between the second studs.

15. A levelling device in accordance with claim 14, wherein the third studs are provided on the first and second cross members.

16. A levelling device in accordance with claim 4, wherein a pair of ribs comprising elongate protrusions are provided extending outwardly from a side surface of the second side member.

17. A levelling device in accordance with claim 16, wherein the ribs are oriented parallel to the longitudinal axis of the second side member and are adjacent each other to define an elongate gap, and wherein a first of the ribs is planar and a second of the ribs is arcuate such that a concave face thereof is adjacent the planar first rib.

18. A levelling device in accordance with claim 4, wherein the electrical socket pins extend outwardly from a first side surface of the body.

19. A levelling device in accordance with claim 18, wherein there is provided a pair of cylindrical lugs located adjacent opposed ends of the body portion on a second. side of the body portion for engaging with apertures in a wall plate for receiving securing screws, and wherein the openings are provided in the body portion extending from the first side surface through to the interior of the lugs such that a screwdriver may be passed through the openings from the first side surface and out of the centre of the lugs to secure a wall plate engaged with the levelling device.

20. A levelling device in accordance with claim 19, wherein the pair of first studs is provided extending outwardly from the first side surface of the body for engaging with apertures in a wall plate, and wherein the studs are received in holes in the body portion such that outer ends thereof extend beyond the body portion and inner ends are contained within the holes and wherein the studs are spring biased such that the studs may be pushed inwardly into the holes but will move back outwardly from the holes when released.

21. A levelling device in accordance with claim 18, wherein a central member is provided extending generally between a midpoint of the first side member and a midpoint of the second side member such that a first opening is defined between the first end member and the central member a second opening is defined between the second end member and the central member, the first level indicator being provided in the first opening and the second level indicator being provided in the second opening, and wherein the electrical socket pins are located on the central member, the first cylindrical lugs and the first studs are located on the first end member and the second cylindrical lugs and the second studs are located on the second end member.
